(19) United States
(12) Patent Application Publication
(10) Pub. No.: US 2026/0064207 A1
(43) Pub. Date: Mar. 5, 2026

(54) TACTILE SENSATION GENERATION SYSTEM, TACTILE SENSATION GENERATION METHOD AND TRAINING METHOD OF GENERATIVE MODEL

(71) Applicant: INDUSTRIAL TECHNOLOGY RESEARCH INSTITUTE, Hsinchu (TW)

(72) Inventors: Wan-Hsin HSIEH, Hsinchu City (TW); Yung-Cheng LIN, Kaohsiung City (TW); Heng-Yin CHEN, Hsinchu City (TW)

(73) Assignee: INDUSTRIAL TECHNOLOGY RESEARCH INSTITUTE, Hsinchu (TW)

(21) Appl. No.: 19/313,468

(22) Filed: Aug. 28, 2025

Related U.S. Application Data
(60) Provisional application No. 63/688,884, filed on Aug. 30, 2024.

(30) Foreign Application Priority Data
Jun. 6, 2025 (TW) 114121249

(51) Int. Cl. G06F 3/01; G06N 3/0475

(52) U.S. Cl. CPC G06F 3/016; G06F 3/014; G06N 3/0475

(57) ABSTRACT

A tactile sensation generation system, a tactile sensation generation method and a training method of a generative model are provided. The tactile sensation generation system includes an encoding unit, a generative model, a generation result verification unit and at least one control unit. The encoding unit is used for translating an object texture image. The generative model is connected to the encoding unit. The generative model is used to infer a texture tactile feature information according to the object texture image. The generation result verification unit is used to verify whether the texture tactile feature information meets a predetermined condition. The at least one control unit is connected to the generation result verification unit. If the texture tactile feature information meets the predetermined condition, the at least one control unit outputs a control signal to an actuator according to the texture tactile feature information.

This application claims the benefit of U.S. Provisional application Ser. No. 63/688,884, filed Aug. 30, 2024, and Taiwan application Serial No. 114121249, filed Jun. 6, 2025, the disclosure of which is incorporated by reference herein in its entirety.

### TECHNICAL FIELD

The disclosure relates to a tactile sensation generation system, a tactile sensation generation method and a training method of a generative model.

### BACKGROUND

In virtual reality applications, if you want to make wearable devices have tactile feedback, you need to use object texture capture equipment. When dealing with various objects, you need to establish corresponding texture tactile sensations for each object. Therefore, a technology that can generate realistic tactile sensations for various objects and provide instant feedback is needed.

### SUMMARY

The disclosure is directed to a tactile sensation generation system, a tactile sensation generation method and a training method of a generative model.

According to one embodiment, a tactile sensation generation system is provided. The tactile sensation generation system includes an encoding unit, a generative model, a generation result verification unit and at least one control unit. The encoding unit is used for translating an object texture image. The generative model is connected to the encoding unit. The generative model is used to infer a texture tactile feature information according to the object texture image. The generation result verification unit is connected to the generative model. The generation result verification unit is used to verify whether the texture tactile feature information meets a predetermined condition. The at least one control unit is connected to the generation result verification unit. If the texture tactile feature information meets the predetermined condition, the at least one control unit outputs a control signal to an actuator according to the texture tactile feature information.

According to another embodiment, a tactile sensation generation method is provided. The tactile sensation generation method includes the following steps. An object texture image is translated. A texture tactile feature information is inferred according to the object texture image. Whether the texture tactile feature information meets a predetermined condition is verified. A control signal is output to at least one actuator according to the texture tactile feature information, if the texture tactile feature information meets the predetermined condition.

According to an alternative embodiment, a training method for a generative model is provided. The training method for the generative model includes the following steps. A plurality of texture image samples are provided. The generative model is trained according to the texture image samples under a constraint of a parameter description information until the texture tactile feature information inferred by the generative model meets a predetermined condition.

### BRIEF DESCRIPTION OF THE DRAWINGS

FIG. 1 illustrates an implementation of a tactile sensation generating technology according to an embodiment of the present disclosure.

FIG. 2 illustrates an implementation of a tactile generation technology according to another embodiment of the present disclosure.

FIG. 3 illustrates a tactile sensation generation system and a tactile sensation generation method according to an embodiment of the present disclosure.

FIG. 4 illustrates a tactile sensation generation system and a tactile sensation generation method according to another embodiment of the present disclosure.

FIG. 5 illustrates a tactile sensation generation system and a tactile sensation generation method according to another embodiment of the present disclosure.

FIG. 6 illustrates a tactile sensation generation system and a tactile sensation generation method according to another embodiment of the present disclosure.

FIG. 7 illustrates a tactile sensation generation system and a tactile sensation generation method according to another embodiment of the present disclosure.

FIG. 8 illustrates a tactile sensation generation system and a tactile sensation generation method according to another embodiment of the present disclosure.

FIG. 9 illustrates an example of a tactile sensation generation system and a tactile sensation generation method according to another embodiment of the present disclosure.

FIG. 10 illustrates an example of a tactile sensation generation system and a tactile sensation generation method according to another embodiment of the present disclosure.

FIG. 11 illustrates an example of a tactile sensation generation system and a tactile sensation generation method according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

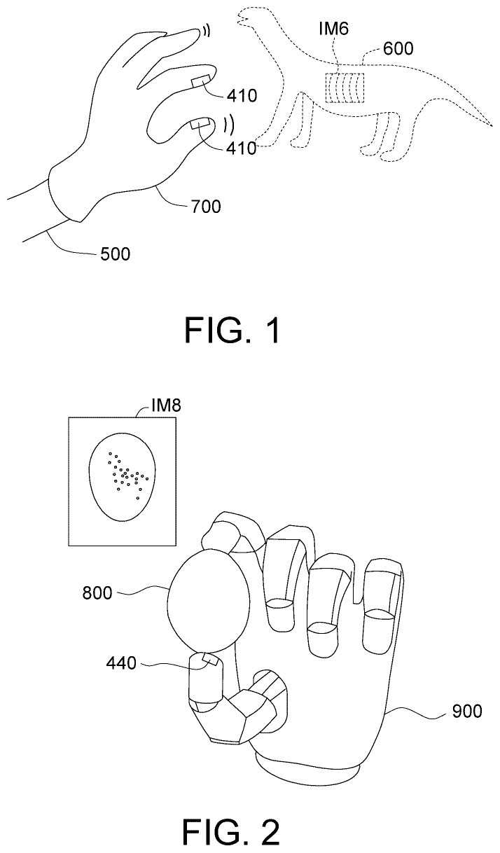

Please refer to FIG. 1, which illustrates an implementation of a tactile sensation generating technology according to an embodiment of the present disclosure. In one embodiment, a user's hand 500 wears a human tactile feedback device 700 (e.g., a glove, but not limited to a glove). In other embodiments, the human tactile feedback device 700 may also be a joystick, a handle, a tactile feedback screen, sportswear, a seat, a watch, a mobile phone case, a backpack, a hat, a helmet, etc. After the object texture image IM6 of the virtual object 600 is extracted, when the user wants to feel the texture tactile sensation of the virtual object 600, the actuator 410 in the human tactile feedback device 700 will generate tactile feedback such as vibration and friction force to the user's hand 500.

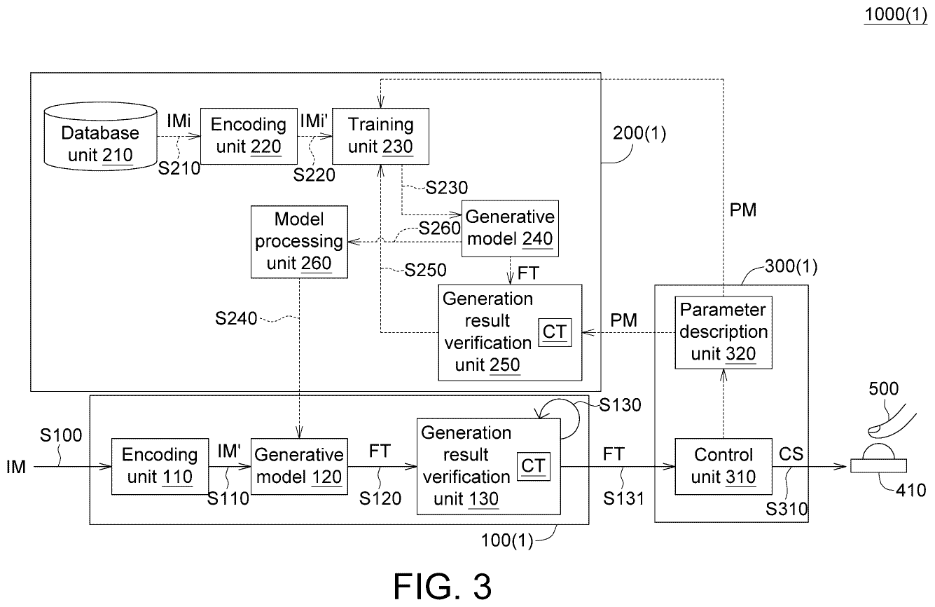

Please refer to FIG. 2, which illustrates an implementation of a tactile generation technology according to another embodiment of the present disclosure. In another embodiment, the system first captures an object texture image IM8 of a physical object 800 to be grasped, and after inferring texture tactile feature information FT (indicated in FIG. 3) through texture image recognition and translation, provides tactile control signals such as gripping strength and friction force to control a mechanical structure actuator 900 (e.g., a robot arm, but not limited to the robot arm shown in FIG. 2, nor limited to a robot arm). In this way, when the mechanical structure actuator 900 grasps the physical object 800, the actuator 440 in the mechanical structure actuator 900 can grasp the physical object 800 with an appropriate gripping strength and friction force. For example, when the physical object 800 is an egg, the actuator 440 in the mechanical structure actuator 900 will reduce the gripping strength, and provide greater friction force to prevent the eggs from breaking or falling. The above FIGS. 1 and 2 are only some implementations of the present disclosure and are not intended to limit the application of the technology disclosed herein.

Please refer to FIG. 3, which illustrates a tactile sensation generation system 1000(1) and a tactile sensation generation method according to an embodiment of the present disclosure. In the embodiment of FIG. 3, the tactile sensation generation system 1000(1) includes a local device 100(1), a remote computing device 200(1), a tactile stimulating device 300(1) and an actuator 410. The actuator 410 is deployed in a human tactile feedback device 700 (e.g., a glove).

The local device 100(1) includes an encoding unit 110, a generative model 120 and a generation result verification unit 130. The functions of the components are summarized as follows. The encoding unit 110 is used to perform image encoding. The generative model 120 is connected to the encoding unit and is used to perform a feature information generation process. The generation result verification unit 130 is connected to the generative model and is used to verify the generation result.

The remote computing device 200(1) includes a database unit 210, an encoding unit 220, a training unit 230, a generative model 240, a generation result verification unit 250 and a model processing unit 260. The functions of the components are summarized as follows. The database unit 210 is used to store various types of data. The encoding unit 220 is connected to the database unit 210 and is used to perform image encoding. The training unit 230 is connected to the encoding unit 220 and is used to train the model. The generative model 240 is connected to the training unit 230 and is used to generate various information using artificial intelligence technology. The generation result verification unit 250 is connected to the generative model 240 and is used to verify the generation result. The model processing unit 260 is connected to the generative model 240 and is used to process a model (such as a compression process or a distillation process).

The database unit 210 is, for example, any type of fixed or removable random access memory (RAM), read-only memory (ROM), flash memory, hard disk drive (HDD), solid state drive (SSD) or similar element or a combination of the above elements, and is used to store multiple modules or various application programs that can be executed by the processor.

The tactile stimulating device 300(1) includes a control unit 310 and a parameter description unit 320. The control unit 310 is connected to the generation result verification unit 130 and the actuator 410 to control the actuator 410. The parameter description unit 320 is connected to the control unit 310 and the generation result verification unit 250 to provide various parameter limits.

The encoding unit 110, the generative model 120, the generation result verification unit 130, the encoding unit 220, the training unit 230, the generative model 240, the generation result the verification unit 250, the model processing unit 260, the control unit 310 and/or the parameter description unit 320 is, for example, a circuit, a circuit board, a storage device for storing program codes or a chip. The chip is, for example, a central processing unit (CPU), a programmable general-purpose or special-purpose micro control unit (MCU), a microprocessor, digital signal processor (DSP), a programmable controller, an application specific integrated circuit (ASIC), a graphics processing unit (GPU), a Neural-network Processing Unit (NPU), an image signal processor (ISP), an image processing unit (IPU), an arithmetic logic unit (ALU), a complex programmable logic device (CPLD), a field programmable gate array (FPGA) or other similar elements or combinations of the above elements.

In one embodiment, the local device 100(1), the tactile stimulating device 300(1) and the actuator 410 are, for example, deployed in the human tactile feedback device 700. Alternatively, in another embodiment, only the tactile stimulating device 300(1) and the actuator 410 are deployed in the human tactile feedback device 700. Alternatively, in another embodiment, only the actuator 410 is deployed in the human tactile feedback device 700.

In FIG. 3, the dotted lines represent the actions of model training, and the solid lines represent the actions of inference and tactile sensation generation. In the tactile sensation generation system 1000(1) in FIG. 3, after the remote computing device 200(1) trains the generative model 240, the generative model 240 could be processed to become the generative model 120. The processed generative model 120 could be loaded into the local device 100(1). After the object texture image IM is input into the local device 100(1), the texture tactile feature information FT could be generated in real time through the generative model 120, and then input to the tactile stimulating device 300(1) to control the actuator 410, so as to generate various tactile sensations in real time. The operation of each component is described in detail below through the tactile sensation generation method.

As shown in FIG. 3, the tactile sensation generation method includes steps S100, S110, S120, S130, S131, and S310. In the step S100, the encoding unit 110 of the local device 100(1) translates the object texture image IM. The object texture image IM is, for example, a color photo or a black and white photo.

Then, in the step S110, the encoding unit 110 of the local device 100 (1) converts the object texture image IM into an encoded information IM′ readable by the generative model 120. The encoded information IM′ is, for example, a vector information.

Next, in the step S120, the generative model 120 of the local device 100(1) infers the texture tactile feature information FT according to the encoded information IM′ of the object texture image IM. The texture tactile feature information FT is, for example, a height of a surface bump, a spatial gradient of variation, an undulation variation period, an amplitude of undulation variation, a direction of friction force, a friction coefficient, a surface variation curve, a principal component value or an intrinsic mode function value.

Then, in the step S130, the generation result verification unit 130 of the local device 100(1) verifies whether the texture tactile feature information FT meets a predetermined condition CT. If the texture tactile feature information FT does not meet the predetermined condition CT, a prompt indicating that the touch cannot be recognized is output; if the texture tactile feature information FT meets the predetermined condition CT, the process proceeds to the step S131. The predetermined condition CT is, for example, whether the Contrastive Language-Image Pretraining (CLIP) index is greater than 0.3.

In the step S131, the generation result verification unit 130 transmits the texture tactile feature information FT to the control unit 310 of the tactile stimulating device 300(1).

Next, in the step S310, the control unit 310 of the tactile stimulating device 300(1) outputs a control signal CS to the actuator 410 according to the texture tactile feature information FT. The control signal CS is used to control, for example, a vibration frequency, a vibration intensity, a waveform, a pulse width, a pulse frequency, a protrusion height, a depression depth, a friction coefficient, a normal force intensity, or a lateral force intensity.

After the object texture image IM is input to the local device 100(1) through the above steps, the texture tactile feature information FT could be generated in real time through the generative model 120 and sent to the tactile stimulating device 300(1) to control the actuator 410 to generate various tactile sensations in real time. The generative model 120 is the result of processing by the generative model 240 trained by the remote computing device 200(1). The training method of the generative model 240 is further described below. The training method of the generative model 240 includes steps S210 to S260.

In the step S210, the database unit 210 provides a plurality of object texture image samples IMi to the encoding unit 220. The object texture image samples IMi are, for example, photos of various object textures.

Next, in the step S220, the encoding unit 220 of the remote computing device 200(1) converts the object texture image sample IMi into an encoded information IMi′ readable by the training unit 230. The encoded information IMi′ is, for example, a vector information.

Then, in the step S230, under the constraint of a parameter description information PM, the training unit 230 performs training of the generative model 240 according to the encoded information IMi′ of the object texture image samples IMi. The parameter description information PM is used to set, control or describe various variables or setting values of the operating characteristics of the tactile stimulating device and/or the actuator. The parameter description information PM includes tactile feelings by a single or a complex tactile feedback device, where tactile feelings include undulating tactile feeling provided by deformation feedback/roughness tactile feeling provided by vibration feedback/stickiness tactile feeling provided by friction feedback, Just-noticeable difference (JND), or other similar parameters or a combination of the above parameters.

Next, in the step S250, the generation result verification unit 250 verifies whether the texture tactile feature information FT inferred by the generative model 240 meets the predetermined condition CT. If it does not meet the predetermined condition CT, the process returns to the step S230 and retrains until the texture tactile feature information FT inferred by the generative model 240 meets the predetermined condition CT. The predetermined condition CT is, for example, CLIP index greater than 0.3.

Alternatively, in another embodiment, the parameter description information PM may not be provided to the training unit 230, but the predetermined condition CT may be directly added, so that the trained generative model 240 could also meet the restrictions of the parameter description information PM.

Then, in the step S260, the model processing unit 260 processes the trained generative model 240, such as model compression or distillation, to obtain the generative model 120.

Next, in the step S240, the processed generative model 120 is loaded into the local device 100(1). When the local device 100(1) receives the object texture image IM, it could infer the corresponding texture tactile feature information FT, and provide the texture tactile feature information FT to the tactile stimulating device 300(1) so that the actuator 410 could provide tactile feedback to the user.

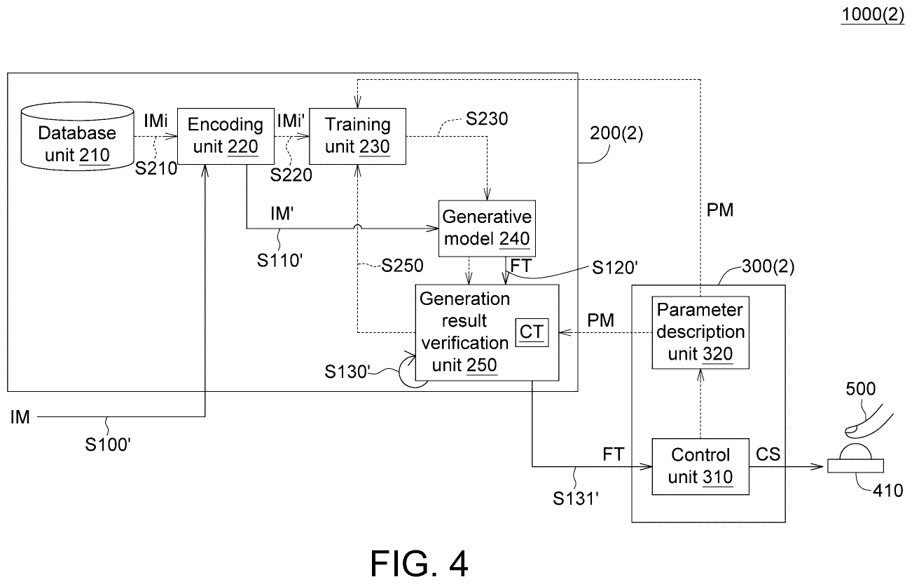

Please refer to FIG. 4, which illustrates a tactile sensation generation system 1000(2) and a tactile sensation generation method according to another embodiment of the present disclosure. In FIG. 4, the dotted lines represent the actions of model training, and the solid lines represent the actions of inference and tactile sensation generation. In the embodiment of FIG. 4, the tactile sensation generation system 1000(2) includes a remote computing device 200(2), a tactile stimulating device 300(2) and an actuator 410. The remote computing device 200(2) includes a database unit 210, an encoding unit 220, a training unit 230, a generative model 240 and a generation result verification unit 250. The tactile stimulating device 300(2) includes a control unit 310 and a parameter description unit 320.

In this embodiment, the steps S100′, S110′, S120′, S130′, and S131′ of the tactile sensation generation method are executed in the remote computing device 200(2). For example, in the step S100′, the encoding unit 220 of the remote computing device 200(2) translates the object texture image IM. In the step S110′, the encoding unit 220 of the remote computing device 200(2) converts the object texture image IM into the encoded information IM′ that could be read by the generative model 240. In the step S120′, the generative model 240 of the remote computing device 200(2) infers the texture tactile feature information FT based on the encoded information IM′ of the object texture image IM. In the step S130′, the generation result verification unit 250 of the remote computing device 200(2) verifies whether the texture tactile feature information FT meets the predetermined condition CT. If the texture tactile feature information FT does not meet the predetermined condition CT, the process terminates; if the texture tactile feature information FT meets the predetermined condition CT, the process proceeds to the step S131′. In the step S131′, the generation result verification unit 250 transmits the texture tactile feature information FT to the control unit 310 of the tactile stimulating device 300(1).

In this embodiment, the training method of the generative model 240 includes the above steps S210, S220, S230, and S250. These steps are also executed on the remote computing device 200(2) and will not be described in detail here.

The tactile sensation generation method and the training method of the embodiment of FIG. 4 are both executed on the remote computing device 200(2), so the generative model 240 does not need to undergo a compression process after training.

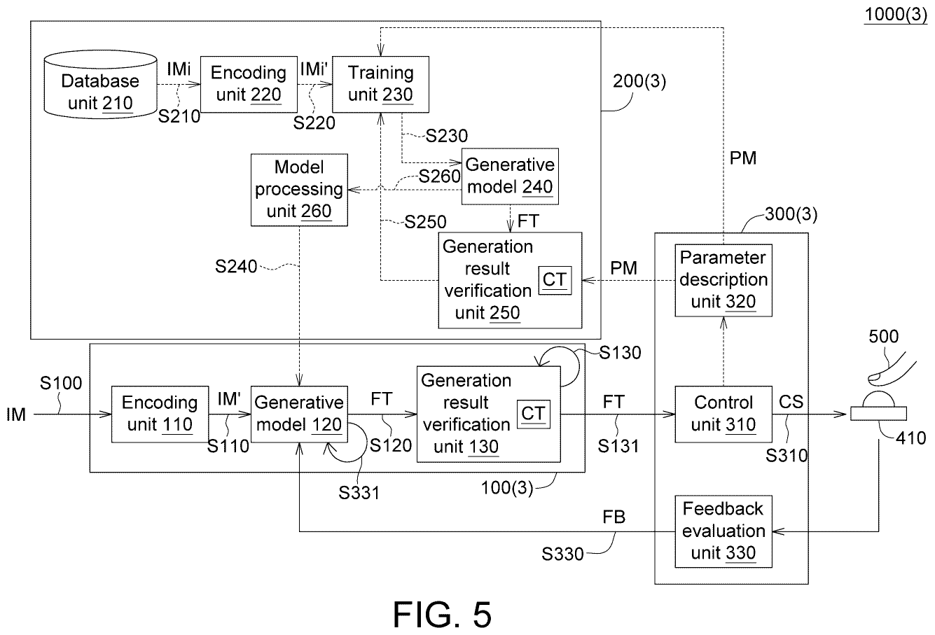

Please refer to FIG. 5, which illustrates a tactile sensation generation system 1000(3) and a tactile sensation generation method according to another embodiment of the present disclosure. In FIG. 5, the dotted lines represent the actions of model training, and the solid lines represent the actions of inference and tactile sensation generation. In the embodiment of FIG. 5, the tactile sensation generation system 1000(3) includes a local device 100(3), a remote computing device 200(3), a tactile stimulating device 300(3) and an actuator 410. The local device 100(3) includes an encoding unit 110, a generative model 120 and a generation result verification unit 130. The remote computing device 200(3) includes a database unit 210, an encoding unit 220, a training unit 230, a generative model 240, a generation result verification unit 250 and a model processing unit 260. The tactile stimulating device 300(3) includes a control unit 310, a parameter description unit 320 and a feedback evaluation unit 330. The feedback evaluation unit 330 is, for example, a circuit, a circuit board, a storage device storing program codes or a chip.

In the embodiment of FIG. 5, the tactile sensation generation method further includes steps S330 and S331. In the step S330, the feedback evaluation unit 330 provides a feedback information FB to a user. The feedback evaluation unit 330 is connected to the actuator 410 and the generative model 120. When the actuator 410 generates a tactile sensation, the user could manually input the tactile sensation to the generative model 120, such as feeling that the vibration amplitude is too small or the inflation amplitude is too large.

Then, in the step S331, the generative model 120 optimizes the texture tactile feature information FT according to the feedback information FB. For example, the texture tactile feature information FT output by the generative model 120 may be adjusted in proportion or weight according to the feedback information FB, so that the control unit 310 could output an appropriate control signal CS (for example, to enhance or weaken the vibration amplitude or inflation amplitude of the actuator 410).

In this embodiment, the user could provide feedback on his or her tactile sensation, and the strength of the actuator 410 could be adjusted accordingly in real time, so that the user could have a better experience during use.

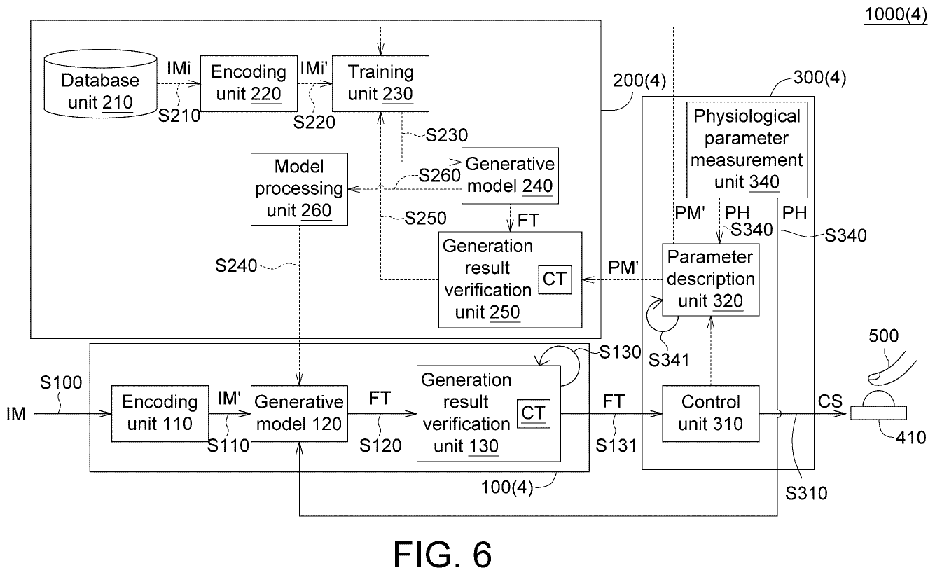

Please refer to FIG. 6, which illustrates a tactile sensation generation system 1000(4) and a tactile sensation generation method according to another embodiment of the present disclosure. In FIG. 6, the dotted lines represent the actions of model training, and the solid lines represent the actions of inference and tactile sensation generation. In the embodiment of FIG. 6, the tactile sensation generation system 1000(4) includes a local device 100(4), a remote computing device 200(4), a tactile stimulating device 300(4) and an actuator 410. The local device 100(4) includes an encoding unit 110, a generative model 120 and a generation result verification unit 130. The remote computing device 200(4) includes a database unit 210, an encoding unit 220, a training unit 230, a generative model 240, a generation result verification unit 250 and a model processing unit 260. The tactile stimulating device 300(4) includes a control unit 310, a parameter description unit 320 and a physiological parameter measurement unit 340. The physiological parameter measurement unit 340 is, for example, a smart watch, a smart bracelet, a headset, an in-ear headset, or a smart garment.

In the embodiment of FIG. 6, the tactile sensation generation method further includes steps S340 and S341. In the step S340, the physiological parameter measurement unit 340 performs measurement to obtain a physiological parameter measurement signal PH of a user. When the user uses the actuator 410, the physiological parameter measurement unit 340 simultaneously measures the user's physiological values, such as blood pressure, heart rate, body temperature, skin galvanic response or myoelectric signal, and transmits the physiological parameter measurement signal PH to the parameter description unit 320.

Then, in the step S341, the parameter description unit 320 optimizes the texture tactile feature information FT according to the physiological parameter measurement signal PH.

For example, the physiological parameter measurement unit 340 is connected to the parameter description unit 320, and the parameter description unit 320 sets the parameter description information PM′ according to the physiological parameter measurement signal PH. Therefore, when the adjusted parameter description information PM′ is transmitted to the training unit 230 of the remote computing device 200(4) for training, the generated generative model 240 could be more in line with the user's personalized model.

Alternatively, the adjusted parameter description information PM′ could also be transmitted to the generation result verification unit 250, and the predetermined condition CT could be directly added to allow the trained generative model 240 to meet the constraints of the parameter description information PM′.

Alternatively, the physiological parameter measurement signal PH may also be transmitted to the generative model 120 of the local device 100(4) to directly adjust the generated texture tactile feature information FT, such as adjusting the proportion or weight, so that the control unit 310 could output an appropriate control signal CS, such as enhancing or weakening the vibration amplitude or inflation amplitude of the actuator 410.

In the embodiment of FIG. 6, the user's physiological values are measured. When the user's emotions are overreacting, blood pressure is too high, or heart rate is too fast, the parameters could be adjusted appropriately according to the user's physical condition to train a generative model 240, 120 that is more suitable for the user's physiological condition and generate a more suitable texture tactile feature information FT, thereby reducing the stimulation to the user and allowing the user to have a better tactile experience during the experience.

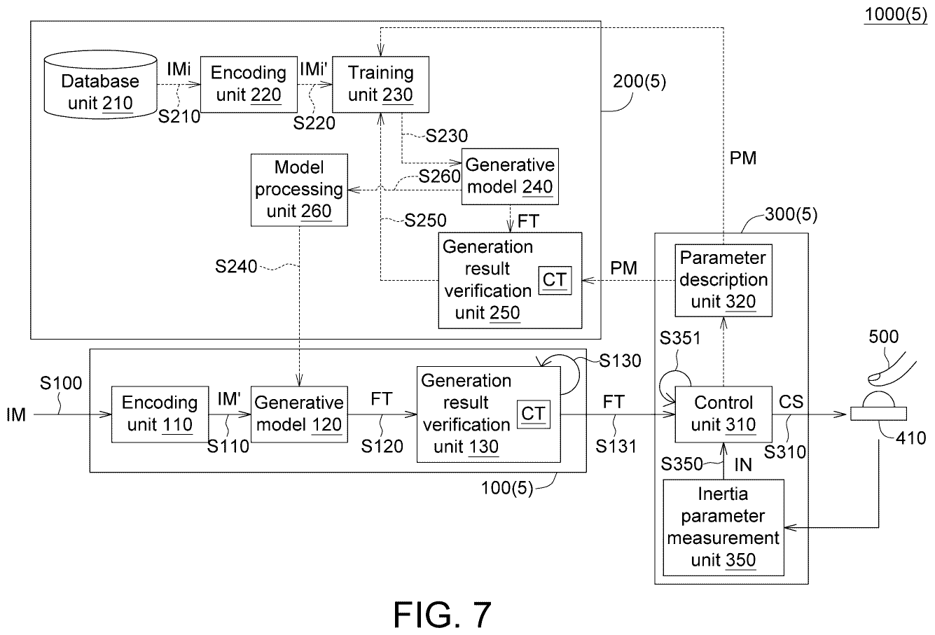

Please refer to FIG. 7, which illustrates a tactile sensation generation system 1000(5) and a tactile sensation generation method according to another embodiment of the present disclosure. In the FIG. 7, the dotted lines represent the actions of model training, and the solid lines represent the actions of inference and tactile sensation generation. In the embodiment of FIG. 7, the tactile sensation generation system 1000(5) includes a local device 100(5), a remote computing device 200(5), a tactile stimulating device 300(5) and an actuator 410. The local device 100(5) includes an encoding unit 110, a generative model 120 and a generation result verification unit 130. The remote computing device 200(5) includes a database unit 210, an encoding unit 220, a training unit 230, a generative model 240, a generation result verification unit 250 and a model processing unit 260. The tactile stimulating device 300(5) includes a control unit 310, a parameter description unit 320 and an inertia parameter measurement unit 350. The inertia parameter measurement unit 350 is connected to the control unit 310 and the actuator 410. The inertia parameter measurement unit 350 is, for example, an accelerometer, a gyroscope or a magnetometer, for measuring acceleration and angular velocity.

In the embodiment of FIG. 7, the tactile sensation generation method further includes steps S350 and S351. In the step S350, the inertia parameter measurement unit 350 measures an inertia parameter signal IN of the actuator 410.

Then, in the step S351, the control unit 310 optimizes the control signal CS according to the inertia parameter signal IN. For example, when the actuator 410 tilts to the right to touch the right side of the virtual object, the actuator 410 provides appropriate tactile perception according to the touch position.

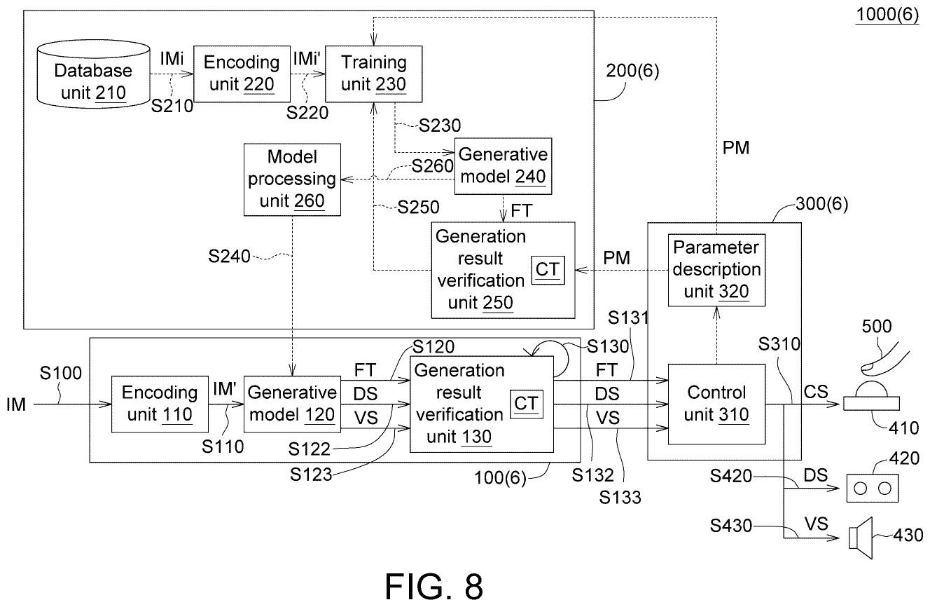

Please refer to FIG. 8, which illustrates a tactile sensation generation system 1000(6) and a tactile sensation generation method according to another embodiment of the present disclosure. In FIG. 8, the dotted lines represent the actions of model training, and the solid lines represent the actions of inference and tactile sensation generation. In the embodiment of FIG. 8, the tactile sensation generation system 1000(6) includes a local device 100(6), a remote computing device 200(6), a tactile stimulating device 300(6), an actuator 410, a display 420, and a speaker 430. The local device 100(6) includes an encoding unit 110, a generative model 120, and a generation result verification unit 130. The remote computing device 200(6) includes a database unit 210, an encoding unit 220, a training unit 230, a generative model 240, a generation result verification unit 250 and a model processing unit 260. The tactile stimulating device 300(6) includes a control unit 310 and a parameter description unit 320.

In the embodiment of FIG. 8, the tactile sensation generation method further includes steps S122, S123, S132, S133, S420, and S430.

In the step S122, the generative model 120 infers an object text description information DS based on the object texture image IM.

In the step S123, the generative model 120 infers an object sound feature information VS based on the object texture image IM. The generative model 120 is, for example, a multimodal generative model, and the step S122 and the step S123 may be executed simultaneously or separately.

Then, in the step S132, the generation result verification unit 130 transmits the object text description information DS to the control unit 310 of the tactile stimulating device 300(1).

In the step S133, the generation result verification unit 130 transmits the object sound feature information VS to the control unit 310 of the tactile stimulating device 300(1).

Next, in the step S420, the control unit 310 outputs the object text description information DS to a display 420.

In the step S430, the control unit 310 outputs the object sound feature information VS to a speaker 430.

For example, when the virtual object 600 touched by the user is a dinosaur, the display 420 will display the text “dinosaur” or “giant carnivore”, and the speaker 430 will play the sound of the dinosaur, so that the user could feel more realistic during the touching process.

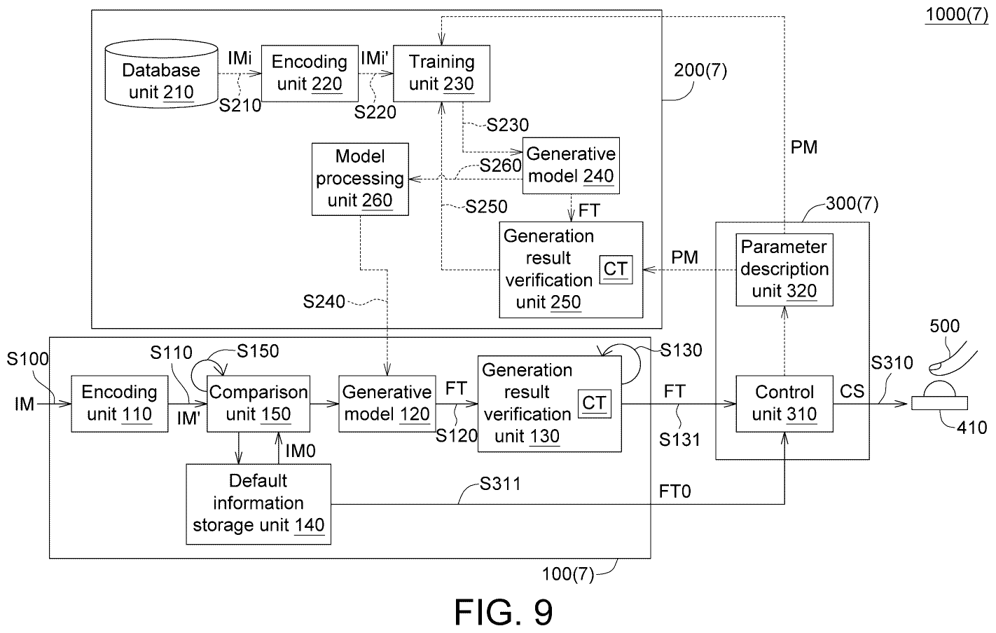

Please refer to FIG. 9, which illustrates an example of a tactile sensation generation system 1000(7) and a tactile sensation generation method according to another embodiment of the present disclosure. In FIG. 9, the dotted line represents the action of model training, and the solid line represents the action of inference and tactile sensation generation. In the embodiment of FIG. 9, the tactile sensation generation system 1000(7) includes a local device 100(7), a remote computing device 200(7), a tactile stimulating device 300(7) and an actuator 410. The local device 100(7) includes an encoding unit 110, a generative model 120, a default information storage unit 140, a comparison unit 150 and a generation result verification unit 130. The remote computing device 200(7) includes a database unit 210, an encoding unit 220, a training unit 230, a generative model 240, a generation result verification unit 250 and a model processing unit 260. The tactile stimulating device 300(7) includes a control unit 310 and a parameter description unit 320. The comparison unit 150 is, for example, a circuit, a circuit board, a storage device storing program code, or a chip. The default information storage unit 140 is used to store at least one pre-stored texture image IMO and at least one corresponding pre-stored texture tactile feature information FT0. The default information storage unit 140 is, for example, any types of fixed or removable random access memory or hard disk.

In the embodiment of FIG. 9, the tactile sensation generation method further includes steps S150 and S311.

In the step S150, the comparison unit 150 compares the received object texture image IM with the pre-stored texture image IMO pre-stored in the default information storage unit 140 to see if they are similar. If there is no similar pre-stored texture image IMO, then the process proceeds to the step S120, S310, S131 to execute the tactile sensation generation; if there is a similar pre-stored texture image IMO, then the process proceeds to the step S311.

In the step S311, the control unit 310 outputs a control signal CS to the actuator 410 according to the pre-stored texture tactile feature information FT0. That is, when the comparison unit 150 compares the object texture image IM and the pre-stored texture image IMO and finds that they are similar, it is no longer necessary to infer through the generative model 120.

Therefore, the control unit 310 could directly output the control signal CS, so that the speed of generating touch is faster and more in line with the application requirements of tactile feedback, and the variation of generated touch is reduced. It can be used in applications with images of preset scenes, such as game scenes or factory robot operations.

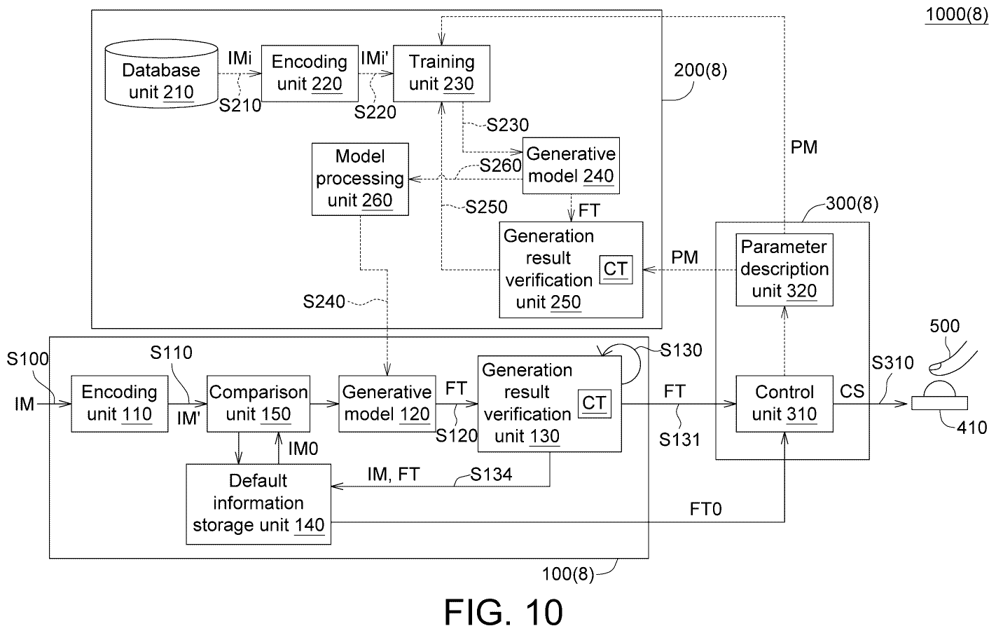

Please refer to FIG. 10, which illustrates an example of a tactile sensation generation system 1000(8) and a tactile sensation generation method according to another embodiment of the present disclosure. In FIG. 10, the dotted line represents the action of model training, and the solid line represents the action of inference and tactile sensation generation. In the embodiment of FIG. 10, the tactile sensation generation system 1000(8) includes a local device 100(8), a remote computing device 200(8), a tactile stimulating device 300(8) and an actuator 410. The local device 100(8) includes an encoding unit 110, a generative model 120, a default information storage unit 140, a comparison unit 150 and a generation result verification unit 130. The remote computing device 200(8) includes a database unit 210, an encoding unit 220, a training unit 230, a generative model 240, a generation result verification unit 250 and a model processing unit 260. The tactile stimulating device 300(8) includes a control unit 310 and a parameter description unit 320.

In the embodiment of FIG. 10, the tactile sensation generation method further includes step S134.

In the step S134, the generation result verification unit 130 uses the texture tactile feature information FT and the corresponding object texture image IM inferred by the generative model 120 as at least one pre-stored texture tactile feature information FT0 and the corresponding at least one pre-stored texture image IMO.

In this embodiment, when the user inputs a similar object texture image IM again, the record of the default information storage unit 140 could be used to read out the pre-stored texture tactile feature information FT0 and the corresponding pre-stored texture image IMO.

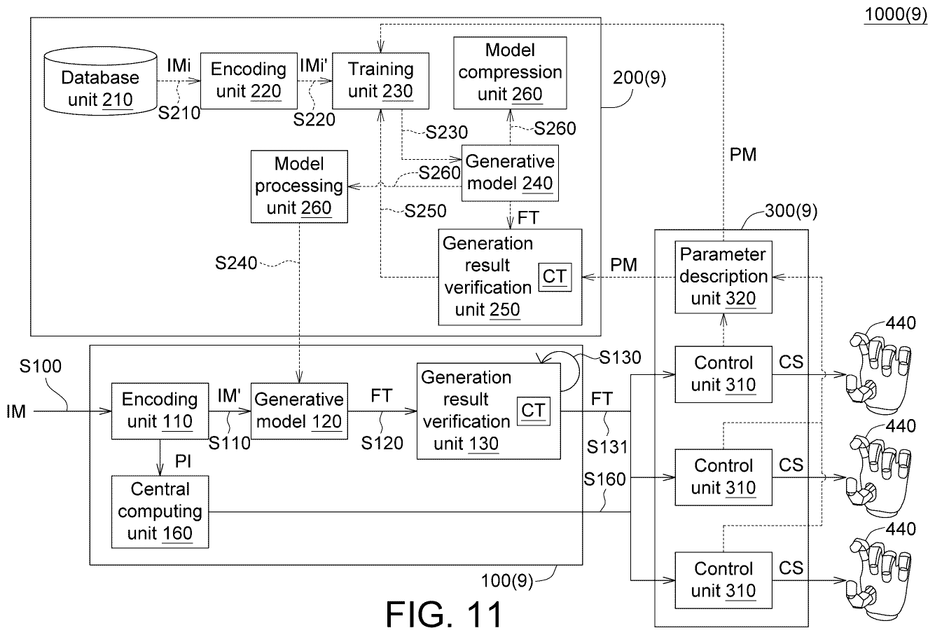

Please refer to FIG. 11, which illustrates an example of a tactile sensation generation system 1000(9) and a tactile sensation generation method according to an embodiment of the present disclosure. In FIG. 11, the dotted line represents the action of model training, and the solid line represents the action of inference and tactile sensation generation. In the embodiment of FIG. 11, the tactile sensation generation system 1000(9) includes a local device 100(9), a remote computing device 200(9), a tactile stimulating device 300(9) and a plurality of actuators 440. The local device 100(9) includes an encoding unit 110, a generative model 120, a generation result verification unit 130 and a central computing unit 160. The remote computing device 200(9) includes a database unit 210, an encoding unit 220, a training unit 230, a generative model 240, a generation result verification unit 250 and a model processing unit 260. The tactile stimulating device 300(9) includes a control unit 310 and a parameter description unit 320. The central computing unit 160 is connected to the encoding unit 110 and the control unit 310. The actuator 440 is deployed in the mechanical structure actuator. The central computing unit 160 is, for example, a circuit, a circuit board, a storage device storing program code, or a chip.

In the embodiment of FIG. 11, the tactile sensation generation method further includes step S160. In the step S160, the central computing unit 160 distributes texture tactile feature information FT to a plurality of control units 310 according to a panoramic image PI. The panoramic image PI shows the spatial relationship between the several control units 310 and corresponding actuators 440. The several control units 310 transmit the control signals CS to corresponding actuators 440. In this way, multiple actuators 440 could be controlled individually or uniformly, which is suitable for scenes such as factories.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A tactile sensation generation system, comprising:
an encoding unit, for translating an object texture image;
a generative model, connected to the encoding unit, wherein the generative model is used to infer a texture tactile feature information according to the object texture image;
a generation result verification unit, connected to the generative model, wherein the generation result verification unit is used to verify whether the texture tactile feature information meets a predetermined condition; and
at least one control unit, connected to the generation result verification unit, wherein if the texture tactile feature information meets the predetermined condition, the at least one control unit outputs a control signal to an actuator according to the texture tactile feature information.

2. The tactile sensation generation system according to claim 1, wherein the texture tactile feature information is a height of a surface bump, a spatial gradient of variation, an undulation variation period, an amplitude of undulation variation, a direction of friction force, a friction coefficient, a surface variation curve, a principal component value, or an intrinsic mode function value, and the control signal is used to control a vibration frequency, a vibration intensity, a waveform, a pulse width, a pulse frequency, a protrusion height, a depression depth, a friction coefficient, a normal force intensity, or a lateral force intensity.

3. The tactile sensation generation system according to claim 1, wherein the generative model and the generation result verification unit are deployed in a local device.

4. The tactile sensation generation system according to claim 1, wherein the generative model and the generation result verification unit are deployed in a remote computing device.

5. The tactile sensation generation system according to claim 1, further comprising:
a feedback evaluation unit, connected to the actuator and the generative model, wherein the feedback evaluation unit is used to provide a feedback information from a user to the generative model to optimize the texture tactile feature information.

6. The tactile sensation generation system according to claim 1, further comprising:
a physiological parameter measurement unit, connected to the generative model, wherein the physiological parameter measurement unit is used to perform a measurement to obtain a physiological parameter measurement signal of a user, and the physiological parameter measurement signal is used to optimize the texture tactile feature information.

7. The tactile sensation generation system according to claim 1, further comprising:
an inertia parameter measurement unit, connected to the at least one control unit and the actuator, wherein the inertia parameter measurement unit is used to measure an inertia parameter signal from the actuator, and the inertia parameter signal is used to optimize the control signal.

8. The tactile sensation generation system according to claim 1, wherein the generative model is further used to infer an object text description information and an object sound feature information according to the object texture image, and the at least one control unit is used to output the object text description information to a display and output the object sound feature information to a speaker.

9. The tactile sensation generation system according to claim 1, further comprising:
a default information storage unit, used to store at least one pre-stored texture image and a pre-stored texture tactile feature information corresponding thereto;
a comparison unit, used to compare whether the object texture image is similar to the at least one pre-stored texture image, wherein if the object texture image is similar to the at least one pre-stored texture image, the at least one control unit outputs the control signal to the actuator according to the pre-stored texture tactile feature information.

10. The tactile sensation generation system according to claim 9, wherein the texture tactile feature information inferred by the generative model and the object texture image are stored into the default information storage unit as the pre-stored texture tactile feature information and the at least one pre-stored texture image.

11. The tactile sensation generation system according to claim 1, wherein number of the at least one control unit is plural, and the tactile sensation generation system further comprises:
a central computing unit, connected to the encoding unit and the control units, wherein the central computing unit is used to distribute the texture tactile feature information to the control units according to on a panoramic image.

12. A tactile sensation generation method, comprising:
translating an object texture image;
inferring a texture tactile feature information according to the object texture image;
verifying whether the texture tactile feature information meets a predetermined condition; and
outputting a control signal to at least one actuator according to the texture tactile feature information, if the texture tactile feature information meets the predetermined condition.

13. The tactile sensation generation method according to claim 12, wherein the texture tactile feature information is a height of a surface bump, a spatial gradient of variation, an undulation variation period, an amplitude of undulation variation, a direction of friction force, a friction coefficient, a surface variation curve, a principal component value, or an intrinsic mode function value, and the control signal is used to control a vibration frequency, a vibration intensity, a waveform, a pulse width, a pulse frequency, a protrusion height, a depression depth, a friction coefficient, a normal force intensity, or a lateral force intensity.

14. The tactile sensation generation method according to claim 12, further comprising:
providing a feedback information from a user; and
optimizing the texture tactile feature information according to the feedback information.

15. The tactile sensation generation method according to claim 12, further comprising:
performing a measurement to obtain a physiological parameter measurement signal of a user; and
optimizing the texture tactile feature information according to the physiological parameter measurement signal.

16. The tactile sensation generation method according to claim 12, further comprising:
measuring an inertia parameter signal from the at least one actuator; and
optimizing the control signal according to the inertia parameter signal.

17. The tactile sensation generation method according to claim 12, further comprising:
inferring an object text description information according to the object texture image;
inferring an object sound feature information according to the object texture image;
outputting the object text description information to a display; and
outputting the object sound feature information to a speaker.

18. The tactile sensation generation method according to claim 12, further comprising:
determining whether an object texture image is similar to at least one pre-stored texture image; and
outputting the control signal to the at least one actuator according to a pre-stored texture tactile feature information, if the object texture image is similar to the at least one pre-stored texture image.

19. The tactile sensation generation method according to claim 18, further comprising:
storing the inferred texture tactile feature information and the object texture image corresponding thereto as the pre-stored texture tactile feature information and the at least one pre-stored texture image.

20. A training method for a generative model, comprising:
providing a plurality of texture image samples; and
training the generative model according to the texture image samples under a constraint of a parameter description information until the texture tactile feature information inferred by the generative model meets a predetermined condition.
